(19) United States
(12) Patent Application Publication
(10) Pub. No.: US 2026/0112266 A1
(43) Pub. Date: Apr. 23, 2026

(54) METHODS, SYSTEMS, AND DEVICES FOR VEHICLE TO VEHICLE SPEED TRACKING AND RECORDING

(71) Applicant: Toyota Motor Engineering & Manufacturing North America, Inc., Plano, TX (US)

(72) Inventor: Markiyan Andruchowycz, Ypsilanti, MI (US)

(73) Assignees: Toyota Motor Engineering & Manufacturing North America, Inc., Plano, TX (US); Toyota Jidosha Kabushiki Kaisha, Toyota-shi (JP)

(21) Appl. No.: 18/923,492

(22) Filed: Oct. 22, 2024

(51) Int. Cl. G08G 1/054; G06V 20/54; G06V 20/58; G08G 1/01; G08G 1/017; G08G 1/04; H04N 7/18

(52) U.S. Cl. CPC G08G 1/054; G06V 20/54; G06V 20/58; G08G 1/0112; G08G 1/0141; G08G 1/0175; G08G 1/04; G06V 2201/08; H04N 7/181

(57) ABSTRACT

Methods, systems, and devices for a speed tracking and recording system for a vehicle. The system may include one or more cameras configured to capture image data of a license plate number of a target vehicle. The system may include one or more distance sensors configured to determine spatial information of the target vehicle relative to the vehicle. The system may include an electronic control unit (ECU). The ECU may determine a speed limit of a road, determine a current speed of the vehicle, receive the spatial information when the target vehicle approaches and/or passes the vehicle, determine a speed of the target vehicle based on the determined current speed and the received spatial information, and control the one or more cameras to capture the image data when the determined speed of the target vehicle is greater than the determined speed limit by at least a threshold margin.

### BACKGROUND

### 1. Field

The present disclosure relates to methods, systems, and/or devices for vehicle to vehicle speed tracking and recording.

### 2. Description of the Related Art

Current vehicles may include systems or devices for determining a current speed of the vehicle as the vehicle is traveling on a road. Moreover, the current vehicles may further include systems or devices that detect other vehicles that are traveling on the same road and within a vicinity of the vehicle. For example, the current vehicles may include a blind spot monitoring system that detects other vehicles and warns a driver of the vehicle when other vehicles are within a blind spot of the driver. However, the current vehicles are generally not able to determine a speed of the other vehicles which may, for example, be used to identify instances of dangerous driving by the other vehicles.

Accordingly, it is desirable to provide methods, systems, and devices for vehicle to vehicle speed tracking and recording.

### SUMMARY

In general, one aspect of the subject matter described in this disclosure may be embodied in a speed tracking and recording system for a monitoring vehicle. The speed tracking and recording system may include one or more cameras. The one or more cameras may capture image data of a license plate number of one or more target vehicles. The speed tracking and recording system may further include one or more distance sensors. The one or more distance sensors may determine spatial information of the one or more target vehicles relative to the monitoring vehicle. The speed tracking and recording system may further include an electronic control unit (ECU) electrically connected to the one or more cameras and the one or more distance sensors. The ECU may determine a speed limit of a road the monitoring vehicle is currently traveling on. The ECU may further determine a current speed of the monitoring vehicle. The ECU may further receive the spatial information from the one or more distance sensors when the one or more target vehicles approach and/or pass the monitoring vehicle on the road. The ECU may further determine a speed of the one or more target vehicles based on the determined current speed of the monitoring vehicle and the received spatial information. The ECU may further control the one or more cameras to capture the image data when the determined speed of the one or more target vehicles is greater than the determined speed limit by at least a threshold margin.

In one aspect, the subject matter may be embodied in a method for tracking and recording a speed of one or more target vehicles by a monitoring vehicle. The method may include determining, via an electronic control unit (ECU) of the monitoring vehicle, a speed limit of a road the monitoring vehicle is currently traveling on. The method may further include determining, via the ECU, a current speed of the monitoring vehicle. The method may further include determining, via one or more distance sensors electrically connected to the ECU, spatial information of the one or more target vehicles relative to the monitoring vehicle when the one or more target vehicles approach and/or pass the monitoring vehicle. The method may further include determining, via the ECU, a speed of the one or more target vehicles based on the determined current speed of the monitoring vehicle and the determined spatial information. The method may further include capturing, via one or more cameras electrically connected to the ECU, image data including a license plate number of the one or more target vehicles when the determined speed of the one or more target vehicles is greater than the determined speed limit by at least a threshold margin.

### BRIEF DESCRIPTION OF THE DRAWINGS

Other systems, methods, features, and advantages of the present disclosure will be apparent to one skilled in the art upon examination of the following figures and detailed description. Component parts shown in the drawings are not necessarily to scale and may be exaggerated to better illustrate the important features of the present disclosure. In the drawings, like reference numerals designate like parts throughout the different views.

FIG. 1 is a block diagram of an example speed tracking and recording system for a vehicle according to an aspect of the disclosure.

FIG. 2 illustrates a top view of an example vehicle including the speed tracking and recording system of FIG. 1 according to an aspect of the disclosure.

FIG. 3 illustrates a top view of the vehicle of FIG. 2 according to an aspect of the disclosure.

FIG. 4 illustrates a top view of the vehicle of FIG. 2 on a road according to an aspect of the disclosure.

FIG. 5 illustrates a top view of the vehicle of FIG. 4 being passed by a target vehicle on the road according to an aspect of the disclosure.

FIG. 6 is a flow diagram of an example process for controlling the speed tracking and recording system of FIG. 1 according to an aspect of the disclosure.

### DETAILED DESCRIPTION

Disclosed herein are methods, systems, devices, and/or vehicles for implementing a speed tracking and recording system. The speed tracking and recording system may include one or more cameras coupled to a monitoring vehicle and one or more distance sensors coupled to the monitoring vehicle. Particular embodiments of the subject matter described in this disclosure may be implemented to realize one or more of the following advantages. The speed tracking and recording system may determine a current speed of the monitoring vehicle and a speed limit of a road the monitoring vehicle is traveling on. When one or more target vehicles approach the monitoring vehicle on the road (e.g., from an opposite lane or from behind the monitoring vehicle and in the same lane as the monitoring vehicle or in one or more adjacent lanes) the speed tracking and recording system may receive, via the one or more distance sensors, spatial information of the one or more target vehicles relative to the monitoring vehicle. The speed tracking and recording system may determine a speed of the one or more target vehicles based on the determined current speed of the monitoring vehicle and the received spatial information. When the determined speed of the one or more target vehicles is greater than the determined speed limit of the road by at least a threshold margin, the speed tracking and recording system may capture, via the one or more cameras, image data of a license plate number of the one or more target vehicles. This may allow the speed tracking and recording system to record instances of dangerous driving not related to the monitoring vehicle.

Moreover, the speed tracking and recording system may include a network access device for transmitting the image data and the determined speed of the one or more target vehicles to a user device and/or a remote database. This may allow the speed tracking and recording system to store the instances of dangerous driving in the cloud for secure storage and/or analysis by a driver of the monitoring vehicle and/or by third parties (e.g., a manufacturer of the monitoring vehicle to gather safety information and data, insurance companies, law enforcement, etc.).

Moreover, the speed tracking and recording system may include a navigation unit for determining a current location of the monitoring vehicle and/or the one or more target vehicles at the time the speed of the one or more target vehicles was determined and/or when the image data was captured. This may help the driver of the monitoring vehicle and/or the third parties to determine where the one or more target vehicles performed the instances of dangerous driving and/or to confirm that the determined speed limit of the road is correct.

Moreover, the threshold margin may be a numerical value and/or a percentage of the determined speed limit of the road, and may be based on a margin of error of the determined speed of the one or more target vehicles, one or more conditions of the road, and/or one or more weather conditions. For example, the threshold margin may increase as the margin of error increases and may be lower when the road is wet, icy, and/or sandy, and/or when it is raining or snowing, and/or when visibility is low due to rain, snow, or fog. The threshold margin may ensure that the speed tracking and recording system records and/or transmits the image data including the license plate number of the one or more target vehicles when there is complete certainty that the one or more target vehicles were traveling above the speed limit of the road and/or at dangerous speeds for the conditions of the road and/or for the weather conditions.

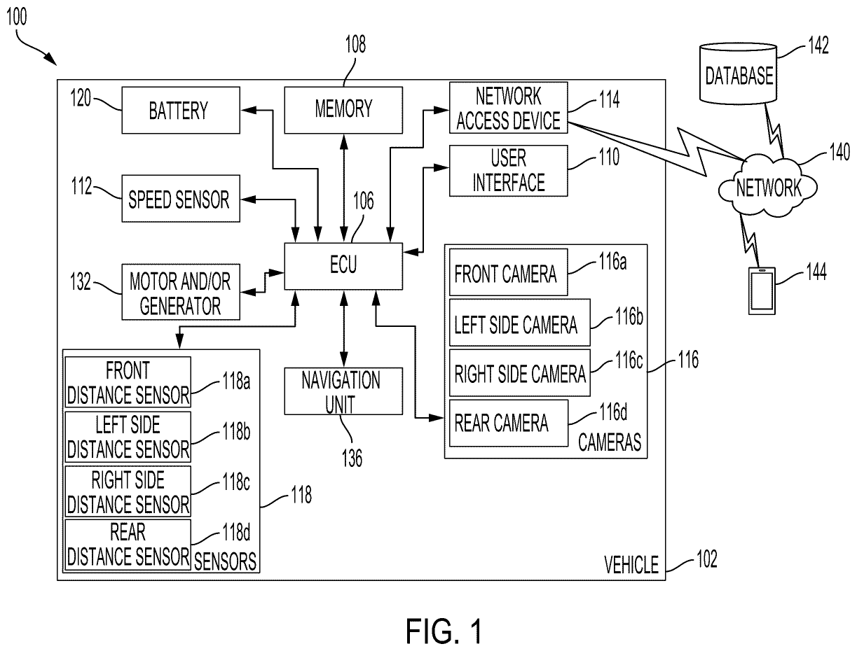

FIG. 1 is a block diagram for an example speed tracking and recording system 100 (also can be referred to as a vehicle to vehicle speed tracking and recording system 100). The speed tracking and recording system 100 or a portion thereof may be retrofitted, coupled to, include, or be included within a vehicle 102 (also may be referred to herein as a monitoring vehicle 102) or separate from the vehicle 102. The vehicle 102 may be a conveyance capable of transporting a person, an object, or a permanently or temporarily affixed apparatus. The vehicle 102 may be a self-propelled wheeled conveyance, such as a car, a sports utility vehicle, a truck, a bus, a van, a motorcycle, or other motor, battery, or fuel cell driven vehicle. For example, the vehicle 102 may be an electric vehicle, a hybrid vehicle, a plug-in hybrid vehicle, a hydrogen fuel cell vehicle, or any other type of vehicle that has a fuel cell, a motor, an engine, and/or a generator. Other examples of vehicles include bicycles, trains, planes, or boats, and any other form of conveyance that is capable of transportation. The vehicle 102 may be semi-autonomous or autonomous. That is, the vehicle 102 may be self-maneuvering and navigate without human input. An autonomous vehicle may have and use one or more sensors and/or a navigation unit to drive autonomously.

The speed tracking and recording system 100 and/or the vehicle 102 may include a motor and/or generator 132 and/or a battery 120. The motor and/or generator 132 may be located within an engine bay of the vehicle 102. For example, the motor and/or generator 132 may be an internal combustion engine (ICE). In this regard, the motor and/or generator 132 may combust an air and fuel mixture to provide power to the vehicle 102 and/or components of the vehicle 102 and/or the speed tracking and recording system 100. Accordingly, the motor and/or generator 132 can cause the vehicle 102 to accelerate, decelerate, or maintain a desired velocity. The motor and/or generator 132 may include combinations of an ICE and an electric motor, such as for hybrid electric vehicle (HEV) applications, for example. In examples, the motor and/or generator 132 may be an electric motor, such as for battery electric vehicle (BEV) applications, for example. In this regard, the motor and/or generator 132 may be an electric motor and an electric generator that converts electrical energy into mechanical power, such as torque, and converts mechanical power into electrical energy. The motor and/or generator 132 may be electrically connected to the battery 120. The motor and/or generator 132 may convert energy from the battery 120 into mechanical power, and may provide energy back to the battery 120, for example, via regenerative braking. The battery 120 may be electrically connected to the motor and/or generator 132 and may provide electrical energy to and/or receive electrical energy from the motor and/or generator 132. The battery 120 may provide electrical energy to the speed tracking and recording system 100.

The speed tracking and recording system 100 and/or the vehicle 102 may further include one or more processors, such as an electronic control unit (ECU) 106. The ECU 106 may be implemented as a single ECU or in multiple ECUs. The ECU 106 may be electrically connected to some or all of the components of the vehicle 102 and/or the speed tracking and recording system 100 (e.g., via a controller area network (CAN) bus and/or other protocols). For example, the ECU 106 may be electrically connected to the motor and/or generator 132, the battery 120, a memory 108, a user interface 110, a network access device 114, a navigation unit 136, a speed sensor 112, one or more cameras 116, and/or one or more distance sensors 118. The ECU 106 may include one or more processors (or controllers) specifically designed for controlling operations of the vehicle 102, such as accelerating, braking, autonomous driving, parking (or parking assistance), etc. Moreover, the ECU 106 may control a panoramic view monitor (PVM) of the vehicle 102 (e.g., including the user interface 110, the one or more cameras 116, and/or the one or more distance sensors 118). In examples, the ECU 106 may be and/or include an advanced driver assistance systems (ADAS) sensor fusion ECU, a PVM ECU, an engine control module (ECM), a transmission control module (TCM), a telematics control unit (TCU), an inertial measurement unit (IMU), an in-vehicle infotainment (IVI) ECU, and/or a graphics processing unit (GPU).

The speed tracking and recording system 100 may further include the memory 108. The memory 108 may be electrically connected to the ECU 106. In examples, the memory 108 may be communicatively coupled (e.g., via a network 140 and/or the network access device 114) to the ECU 106 such that the memory 108 is remote from the ECU 106 and/or the vehicle 102. In other examples, the memory 108 may be electrically connected to the ECU 106 and a remote memory (e.g., a remote database 142) may be communicatively coupled to the ECU 106, with the remote memory having similar, additional, and/or different functions as the memory 108 (e.g., greater storage capacity, enabling over-the-air updates, etc.). The memory 108 may store instructions to execute on the ECU 106 and may include one or more of a random access memory (RAM) or other volatile or non-volatile memory. The memory 108 may be a non-transitory memory or a data storage device, such as a hard disk drive, a solid-state disk drive, a hybrid disk drive, or other appropriate data storage, and may further store machine-readable instructions, which may be loaded and executed by the ECU 106. The memory 108 may store vehicle parameters (e.g., a weight of the vehicle 102, dimensions of the vehicle 102, transmission gear information of the vehicle 102, etc.).

The speed tracking and recording system 100 may further include the user interface 110. The user interface 110 may be located within a cabin of the vehicle 102 (e.g., coupled to a dashboard of the vehicle 102). The user interface 110 may provide an interface to a user of the vehicle 102 (e.g., a driver and/or a passenger of the vehicle 102) to interact with and/or receive output from the ECU 106. The user interface 110 may have a user interface element, such as a screen and/or a touchscreen with a button, a switch, a microphone, a speaker, a gesture monitoring sensor, a knob, a graphical user interface (GUI), and/or other input/output devices electrically connected to the ECU 106 to provide input and/or output of information (or data) to and/or from the ECU 106.

The speed tracking and recording system 100 may further include the network access device 114. The network access device 114 may be electrically connected to the ECU 106 and may include a communication port or channel, such as one or more of a Wi-Fi unit, a Bluetooth® unit, a Radio Frequency Identification (RFID) tag or reader, a DSRC unit, a satellite network unit, and/or a cellular network unit for accessing the network 140 (e.g., CDMA, GSM, 3G, 4G, 5G, etc.). The network access device 114 may transmit data to and receive data from devices and systems not directly connected to the vehicle 102. For example, the ECU 106 may communicate with the remote database 142 and/or a user device 144 (e.g., a mobile device, a phone, a tablet, a laptop, etc.) through the network access device 114.

The speed tracking and recording system 100 may further include the navigation unit 136. The navigation unit 136 may be electrically connected to the ECU 106 and may provide vehicle information (or data) and/or navigational map information to the ECU 106. The navigation unit 136 may include and/or be connected to a Global Positioning System (GPS) device. The vehicle information may include a current position and/or location of the vehicle 102, a current time at the current position, a direction of travel, and/or a current speed of the vehicle 102. In examples, the navigation unit 136 may provide the vehicle information (e.g., indicating the current speed of the vehicle 102) to the ECU 106. The ECU 106 and/or the navigation unit 136 may determine the current speed of the vehicle 102 (e.g., in miles per hour (MPH) and/or kilometers per hour (KPH)) based on the vehicle information.

The speed tracking and recording system 100 may further include the speed sensor 112. In examples, the speed tracking and recording system 100 may include a plurality of speed sensors. The speed sensor 112 may be electrically connected to the ECU 106. The speed sensor 112 may be configured to measure, detect, and/or determine the current speed of the vehicle 102. For example, the speed sensor 112 may be and/or include an electronic vehicle speed sensor (e.g., that measures rotation of the motor and/or generator 132 and/or a transmission shaft of the vehicle 102) and/or one or more wheel speed sensors (e.g., that measure rotation of one or more wheels of the vehicle 102). In examples, the speed sensor 112 may provide speed data indicating the current speed of the vehicle 102 to the ECU 106. The ECU 106 and/or the speed sensor 112 may determine the current speed of the vehicle 102 (e.g., in miles per hour (MPH) and/or kilometers per hour (KPH)) based on the speed data.

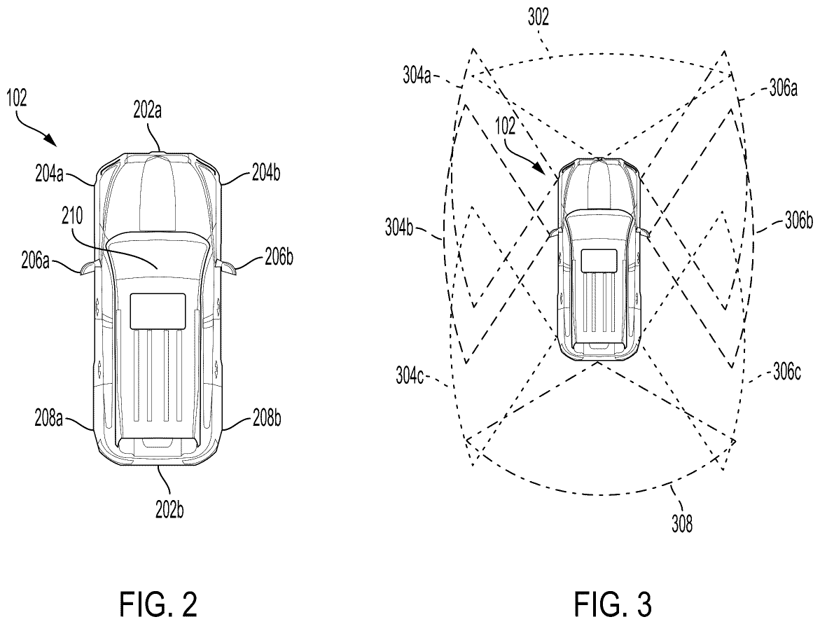

FIG. 2 is a schematic illustrating a top view of an example vehicle 102 including the speed tracking and recording system 100. With combined reference to FIGS. 1 and 2, the speed tracking and recording system 100 may further include the one or more cameras 116. The one or more cameras 116 may be coupled to an exterior of the vehicle 102 and/or an interior of the vehicle 102 such that the one or more cameras 116 look out toward a surrounding area of the vehicle 102. The one or more cameras 116 may be and/or include one or more of an analog camera, a digital camera, a thermal camera, and/or a night vision camera (e.g., utilizing active illumination and/or image intensification). The one or more cameras 116 may provide, capture, and/or record images and/or real-time video of the surrounding area of the vehicle 102. In examples, the one or more cameras 116 (e.g., via the ECU 106) may also have pattern recognition capabilities to view the surrounding area and identify, for example, vehicles, components of vehicles (e.g., a license plate, a side view mirror, etc.), road signs (e.g., speed limit signs), and/or writing (e.g., letters, numbers, symbols, etc.) on the vehicles and/or the road signs. The one or more cameras 116 may include one or more front cameras 116a, one or more left side cameras 116b, one or more right side cameras 116c, and/or one or more rear cameras 116d.

The one or more front cameras 116a may be coupled to a front end of the vehicle 102, such as a front bumper 202a and/or a windshield 210, for example. In examples, the one or more front cameras 116a may include a plurality of front cameras (e.g., with each having a different field of view, orientation, and/or location on the vehicle 102). The one or more front cameras 116a may provide, capture, and/or record real-time video of a forward field of view with respect to the vehicle 102 (e.g., a portion of the surrounding area of the vehicle 102 that is in front of the vehicle 102).

The one or more left side cameras 116b may be coupled to a left side of the vehicle 102, such as a left side mirror 206a, a left front quarter panel (or fender) 204a, a left rear quarter panel (or fender) 208a, a left side door, etc. In examples, the one or more left side cameras 116b may include a plurality of left side cameras (e.g., with each having a different field of view, orientation, and/or location on the vehicle 102). The one or more left side cameras 116b may provide, capture, and/or record real-time video of a leftward field of view with respect to the vehicle 102 (e.g., a portion of the surrounding area of the vehicle 102 that is to the left of the vehicle 102).

The one or more right side cameras 116c may be coupled to a right side of the vehicle 102, such as a right side mirror 206b, a right front quarter panel (or fender) 204b, a right rear quarter panel (or fender) 208b, a right side door, etc. In examples, the one or more right side cameras 116c may include a plurality of right side cameras (e.g., with each having a different field of view, orientation, and/or location on the vehicle 102). The one or more right side cameras 116c may provide, capture, and/or record real-time video of a rightward field of view with respect to the vehicle 102 (e.g., a portion of the surrounding area of the vehicle 102 that is to the right of the vehicle 102).

The one or more rear cameras 116d may be coupled to a rear end of the vehicle 102, such as a rear bumper 202b, a rear window, a tailgate, and/or a liftgate, for example. In examples, the one or more rear cameras 116d may include a plurality of rear cameras (e.g., with each having a different field of view, orientation, and/or location on the vehicle 102). The one or more rear cameras 116d may provide, capture, and/or record real-time video of a rearward field of view with respect to the vehicle 102 (e.g., a portion of the surrounding area of the vehicle 102 that is behind the vehicle 102).

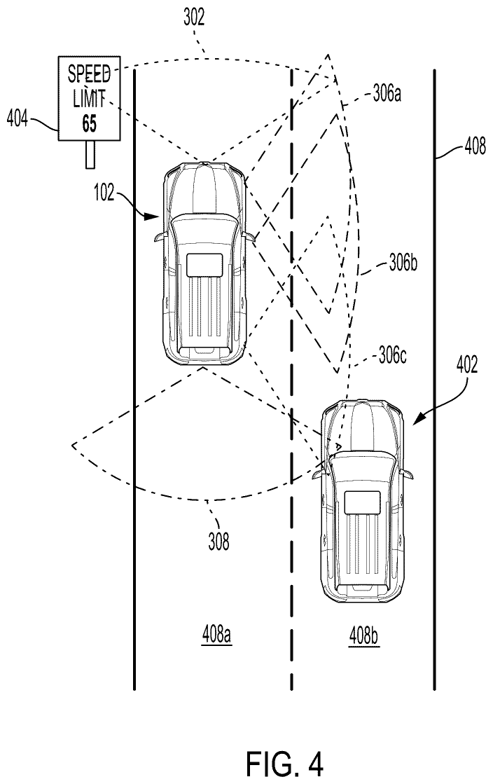

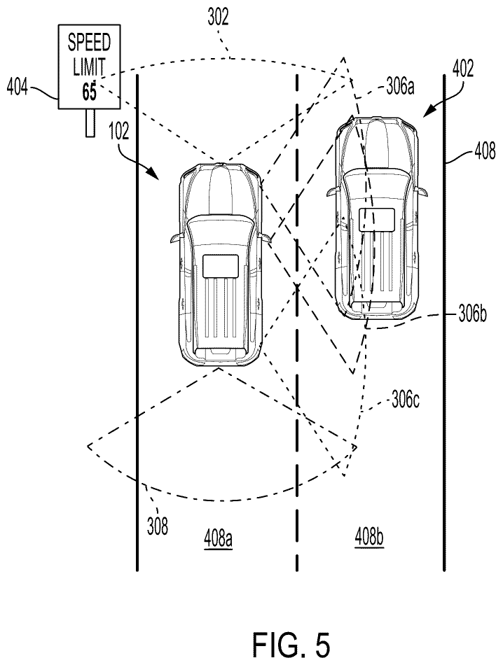

With continued reference to FIGS. 1 and 2, the speed tracking and recording system 100 may further include the one or more distance sensors 118. The one or more distance sensors 118 may be and/or include one or more of a camera, a radar sensor, an ultrasonic sensor, a lidar sensor, and/or another distance measuring sensor. The one or more distance sensors 118 may measure, detect, and/or determine spatial information (or data) of one or more target vehicles 402 (marked in FIGS. 4 and 5) in the surrounding area of the vehicle 102. For example, the one or more distance sensors 118 may periodically or continuously scan (or monitor) the surrounding area of the vehicle 102 to measure, detect, and/or determine the spatial information. The spatial information may be radar data, lidar data, ultrasonic data, and/or image (or video) data, for example. The spatial information may include and/or indicate a size and/or a shape (e.g., a width, a length, a height, etc.) of the one or more target vehicles 402 and/or a position, a direction, and/or a velocity of the one or more target vehicles 402 relative to the vehicle 102 at one or more points in time and/or over one or more periods of time. A location of each of the one or more distance sensors 118 on the vehicle 102 may be known to the ECU 106 (e.g., the location of each of the one or more distance sensors 118 may be stored on the memory 108).

In examples where the one or more distance sensors 118 include one or more cameras (e.g., the one or more cameras 116), the speed tracking and recording system 100 may use monocular and/or binocular depth estimation on image (or video) data captured or recorded by the one or more distance sensors 118 to determine the spatial information.

The one or more distance sensors 118 may include one or more front distance sensors 118a, one or more left side distance sensors 118b, one or more right side distance sensors 118c, and/or one or more rear distance sensors 118d. The one or more front distance sensors 118a may be coupled to the front end of the vehicle 102, such as the front bumper 202a and/or the windshield 210, for example. In examples, the one or more front distance sensors 118a may include a plurality of front distance sensors (e.g., with each having a different orientation and/or location on the vehicle 102).

The one or more left side distance sensors 118b may be coupled to the left side of the vehicle 102, such as the left side mirror 206a, the left front quarter panel (or fender) 204a, the left rear quarter panel (or fender) 208a, the left side door, etc. In examples, the one or more left side distance sensors 118b may include a plurality of left side distance sensors (e.g., with each having a different orientation and/or location on the vehicle 102).

The one or more right side distance sensors 118c may be coupled to the right side of the vehicle 102, such as the right side mirror 206b, the right front quarter panel (or fender) 204b, the right rear quarter panel (or fender) 208b, the right side door, etc. In examples, the one or more right side distance sensors 118c may include a plurality of right side distance sensors (e.g., with each having a different orientation and/or location on the vehicle 102).

The one or more rear distance sensors 118d may be coupled to the rear end of the vehicle 102, such as the rear bumper 202b, the rear window, the tailgate, and/or the liftgate, for example. In examples, the one or more rear distance sensors 118d may include a plurality of rear distance sensors (e.g., with each having a different orientation and/or location on the vehicle 102).

FIG. 3 is a schematic illustrating a top view of the vehicle 102. With combined reference to FIGS. 1 and 3, the speed tracking and recording system 100 may have a plurality of sensor detection zones. For example, the plurality of sensor detection zones may include one or more front sensor detection zones 302, one or more left side sensor detection zones 304a-c, one or more right side sensor detection zones 306a-c, and/or one or more rear sensor detection zones 308. The plurality of sensor detection zones 302, 304a-c, 306a-c, and 308 may each correspond to a respective distance sensor of the one or more distance sensors 118. Accordingly, each of the one or more distance sensors 118 may have a respective sensor detection zone of the plurality of sensor detection zones 302, 304a-c, 306a-c, and 308.

For example, the one or more front distance sensors 118a may have the one or more front sensor detection zones 302, the one or more left side distance sensors 118b may have the one or more left side sensor detection zones 304a-c, the one or more right side distance sensors 118c may have the one or more right side sensor detection zones 306a-c, and/or the one or more rear distance sensors 118d may have the one or more rear sensor detection zones 308. Although FIG. 3 illustrates one front sensor detection zone 302, three left side sensor detection zones 304a-c, three right side sensor detection zones 306a-c, and one rear sensor detection zone 308, the speed tracking and recording system 100 may have any number of front, left side, right side, and/or rear sensor detection zones (e.g., based on a quantity of distance sensors of the one or more distance sensors 118). In examples, the plurality of sensor detection zones 302, 304a-c, 306a-c, and 308 may have a different location and/or shape than what is illustrated in FIG. 3 (e.g., the one or more distance sensors 118 may be positioned at different locations on the vehicle 102 and/or may have different orientations).

The plurality of sensor detection zones 302, 304a-c, 306a-c, and 308 may be or correspond to a detection range and/or area of the one or more distance sensors 118 and/or a field of view of the one or more distance sensors 118. In examples, the plurality of sensor detection zones 302, 304a-c, 306a-c, and 308 may have a cone shape and/or a cylindrical shape (in examples, the plurality of sensor detection zones 302, 304a-c, 306a-c, and 308 may have one or more different shapes). For example, the plurality of sensor detection zones 302, 304a-c, 306a-c, and 308 may have a vertical angle (e.g., corresponding to a vertical beam angle of the one or more distance sensors 118) of 10-30 degrees (in examples, the vertical angle may be less than 10 degrees or more than 30 degrees). In addition, the plurality of sensor detection zones 302, 304a-c, 306a-c, and 308 may have a horizontal angle (e.g., corresponding to a horizontal beam angle of the one or more distance sensors 118) of 30-120 degrees (in examples, the horizontal angle may be less than 30 degrees or more than 120 degrees). The plurality of sensor detection zones 302, 304a-c, 306a-c, and 308 may have a range of less than or equal to 10 feet, 25 feet, and/or 100 feet, for example (in examples, the range may be any other distance, such as more than 100 feet). The range, a position relative to the vehicle 102, and/or dimensions of each of the plurality of sensor detection zones 302, 304a-c, 306a-c, and 308 may be known to the ECU 106.

FIGS. 4 and 5 are schematics illustrating top views of the vehicle 102 on a road 408. Moreover, FIGS. 4 and 5 illustrate the vehicle 102 in a first lane 408a of the road 408 and the one or more target vehicles 402 in a second lane 408b of the road 408, with FIG. 4 being at a first point in time (PIT) and FIG. 5 being at a second PIT that is later in time than the first PIT (e.g., to illustrate the one or more target vehicles 402 passing the vehicle 102). With combined reference to FIGS. 4 and 5 and continuing reference to FIGS. 1 and 3, the speed tracking and recording system 100 may be configured to determine a speed of the one or more target vehicles 402. For example, the ECU 106 may be configured to determine a speed of the one or more target vehicles 402 based on the spatial information (or data) received from the one or more distance sensors 118. In examples, the spatial information may indicate when the one or more target vehicles 402 entered a respective sensor detection zone of the plurality of sensor detection zones 302, 304a-c, 306a-c, and 308.

For example, as the one or more target vehicles 402 pass the vehicle 102, the spatial information may indicate when the one or more target vehicles 402 entered at least two respective sensor detection zones of the plurality of sensor detection zones 302, 304a-c, 306a-c, and 308. The ECU 106 may determine when the one or more target vehicles 402 entered each of the at least two respective sensor detection zones based on the spatial information (e.g., radar data, lidar data, ultrasonic data, and/or image (or video) data) received from the one or more distance sensors 118.

The ECU 106 may determine one or more periods of time between when the one or more target vehicles 402 entered a first respective sensor detection zone of the plurality of sensor detection zones 302, 304a-c, 306a-c, and 308 and one or more subsequent sensor detection zones of the plurality of sensor detection zones 302, 304a-c, 306a-c, and 308 (e.g., a time period between the one or more target vehicles 402 entering a rear right side sensor detection zone 306c and subsequently entering a front right side sensor detection zone 306a). The ECU 106 may determine a speed of the one or more target vehicles 402 based on the determined one or more periods of time. In examples, the one or more periods of time may indicate how long it took the one or more target vehicles 402 to drive through one or more respective sensor detection zones of the plurality of sensor detection zones 302, 304a-c, 306a-c, and 308. For example, the one or more target vehicles 402 and/or a portion of the one or more target vehicles 402 (e.g., a front end, a side view mirror, etc.) may be tracked through the one or more respective sensor detection zones by one or more respective distance sensors of the one or more distance sensors 118.

Moreover, in examples, the one or more distance sensors 118 may determine a distance between the vehicle 102 and the one or more target vehicles 402 at each instance of the one or more target vehicles 402 entering a respective sensor detection zone of the plurality of sensor detection zones 302, 304a-c, 306a-c, and 308. This may be used by the ECU 106 to determine a distance traveled by the one or more target vehicles 402 within the determined one or more periods of time. The ECU 106 may determine the speed of the one or more target vehicles 402 based on the determined one or more periods of time and the determined distance traveled.

In examples, the one or more distance sensors 118 (e.g., the one or more rear distance sensors 118d) may be configured to determine, detect, and/or measure spatial information of the one or more target vehicles 402 as the one or more target vehicles 402 approach the vehicle 102 from behind. The ECU 106 may be configured to determine a speed of the one or more target vehicles 402 based on a period of time between the one or more target vehicles 402 being a first distance from the vehicle 102 (e.g., 50 feet, 100 feet, etc.) and the one or more target vehicles 402 being a second distance from the vehicle 102 (e.g., 5 feet, 10 feet, etc.), for example. Accordingly, the ECU 106 may be configured to determine the speed of the one or more target vehicles 402 as the one or more target vehicles 402 approach the vehicle 102 (e.g., when the one or more target vehicles 402 are in the same lane as the vehicle 102 or a lane adjacent to a current lane of the vehicle 102) and/or pass the vehicle 102 (e.g., when the one or more target vehicles 402 are in one or more lanes adjacent to a current lane of the vehicle 102).

In examples, the ECU 106 may be configured to determine the speed of the one or more target vehicles 402 based on a current speed of the vehicle 102 and the determined one or more time periods and/or the determined distance traveled of the one or more target vehicles 402. By accounting for the current speed of the vehicle 102, the ECU 106 may be more accurate in determining the speed of the one or more target vehicles 402. For example, the ECU 106 may determine the current speed of the vehicle 102 based on the speed data received from the speed sensor 112 and/or the vehicle information received from the navigation unit 136. In examples, the ECU 106 may determine and/or track a speed of the vehicle 102 over the one or more periods of time such that the determined current speed of the vehicle 102 represents the speed of the vehicle 102 during the one or more periods of time. Accordingly, the determined current speed of the vehicle 102 may indicate any speed changes of the vehicle 102 (e.g., acceleration and/or deacceleration) during the one or more periods of time. This may further increase the accuracy of the ECU 106 in determining the speed of the one or more target vehicles 402. In examples, the ECU 106 may determine the speed of the one or more target vehicles 402 by determining a speed of the one or more target vehicles 402 relative to the vehicle 102, and then adding the relative speed to the determined current speed of the vehicle 102.

In examples, the ECU 106 may be configured to determine a speed limit of the road 408. For example, the ECU 106 may be configured to determine the speed limit of the road 408 based on the navigational map information received from the navigation unit 136. The navigational map information may indicate the speed limit of the road 408 that the vehicle 102 is currently traveling upon. In examples, the ECU 106 may determine the speed limit of the road 408 based on a current location of the vehicle 102 (e.g., received from the navigation unit 136). For example, the ECU 106 may utilize the current location of the vehicle 102 to look up the speed limit of the road 408 in a remote database (e.g., the remote database 142).

In examples, in addition or alternatively, the ECU 106 may be configured to determine the speed limit of the road 408 based on road image (or video) data received from the one or more cameras 116. For example, the one or more cameras 116 may be configured to identify a speed limit sign 404 positioned along the road 408 and capture the road image data including the speed limit sign 404. The one or more cameras 116 and/or the ECU 106 may identify the speed limit of the road 408 (e.g., 65 MPH) by analyzing the road image data.

The ECU 106 may compare the determined speed of the one or more target vehicles 402 to the determined speed limit of the road 408. In examples, when the determined speed of the one or more target vehicles 402 is less than or equal to the determined speed limit of the road 408, the speed tracking and recording system 100 may continue to monitor the road 408 for the one or more target vehicles 402. In examples, when the determined speed of the one or more target vehicles 402 is greater than the determined speed limit of the road 408, the speed tracking and recording system 100 may record or capture (e.g., via the one or more cameras 116) image (or video) data indicating or including a license plate number of the one or more target vehicles 402 and/or other identifying information about the one or more target vehicles 402. The image data indicating or including the license plate number may be stored on the memory 108, for example.

In addition or alternatively, in examples, the ECU 106 may transmit (e.g., via the network access device 114) the image data indicating or including the license plate number of the one or more target vehicles 402 and the determined speed of the one or more target vehicles 402 to the user device 144 and/or the remote database 142.

In examples, the speed tracking and recording system 100 may record or capture the image (or video) data indicating or including the license plate number of the one or more target vehicles 402 and/or other identifying information about the one or more target vehicles 402 when the determined speed of the one or more target vehicles 402 is greater than the determined speed limit of the road 408 by at least a threshold margin. The threshold margin may be stored on the memory 108 and/or may be set by a manufacturer of the vehicle 102 and/or a user (e.g., an owner of the vehicle 102) via the user interface 110, for example.

The threshold margin may be a predetermined numerical value (e.g., 1 MPH, 3 MPH, 5 MPH, etc.). For example, if the speed limit of the road 408 is 65 MPH, and the threshold margin is 5 MPH, the speed tracking and recording system 100 may record or capture the image data indicating or including the license plate number of the one or more target vehicles 402 when the determined speed of the one or more target vehicles 402 is greater than or equal to 70 MPH.

In examples, the threshold margin may be a percentage (e.g., 5%, 10%, 15%, etc.) of the determined speed limit. For example, if the determined speed limit of the road 408 is 65 MPH, and the threshold margin is 10% of the determined speed limit, the speed tracking and recording system 100 may record or capture the image data indicating or including the license plate number of the one or more target vehicles 402 when the determined speed of the one or more target vehicles 402 is greater than or equal to 71.5 MPH.

In examples, the threshold margin may be based on a margin of error of the speed tracking and recording system 100 and/or the determined speed of the one or more target vehicles 402. For example, if the speed limit of the road 408 is 65 MPH, and the margin of error is +/−2 MPH, the speed tracking and recording system 100 may record or capture the image data indicating or including the license plate number of the one or more target vehicles 402 when the determined speed of the one or more target vehicles 402 is greater than or equal to 67 MPH.

In examples, the threshold margin may be based on one or more conditions of the road 408 and/or one or more weather conditions of a current location of the vehicle 102. For example, the threshold margin may be lower (e.g., a lower predetermined value or a lower percentage) when the road 408 is wet, icy, or sandy, when it is raining and/or snowing, and/or when visibility is low (e.g., due to rain, snow, fog, or dust). The one or more conditions of the road 408 and/or the one or more weather conditions may be identified or determined, for example, via the one or more cameras 116 (e.g., via image analysis and identification), the one or more distance sensors 118, and/or the navigation unit 136 and the network access device 114. For example, the ECU 106 may determine the one or more road conditions and/or the one or more weather conditions for a current location of the vehicle 102 by receiving road information and/or weather information via the network access device 114. The road information may indicate whether the road 408 is wet, icy, or sandy and the weather information may indicate whether it is raining and/or snowing, and/or whether visibility is low.

The threshold margin may ensure that the image data indicating or including the license plate number of the one or more target vehicles 402 is recorded and/or transmitted when there is complete (or substantial) certainty that the one or more target vehicles 402 are traveling above the speed limit of the road 408 and/or at an unsafe speed for the road conditions of the road 408 and/or the weather conditions.

In examples, along with the image data indicating or including the license plate number of the one or more target vehicles 402, location information such as a location of the vehicle 102 and/or the one or more target vehicles 402 (e.g., at the time the image data was captured) may be transmitted (e.g., via the network access device 114) to the user device 144 and/or the remote database 142. The location information may allow for verification of the speed limit of the road 408, for example.

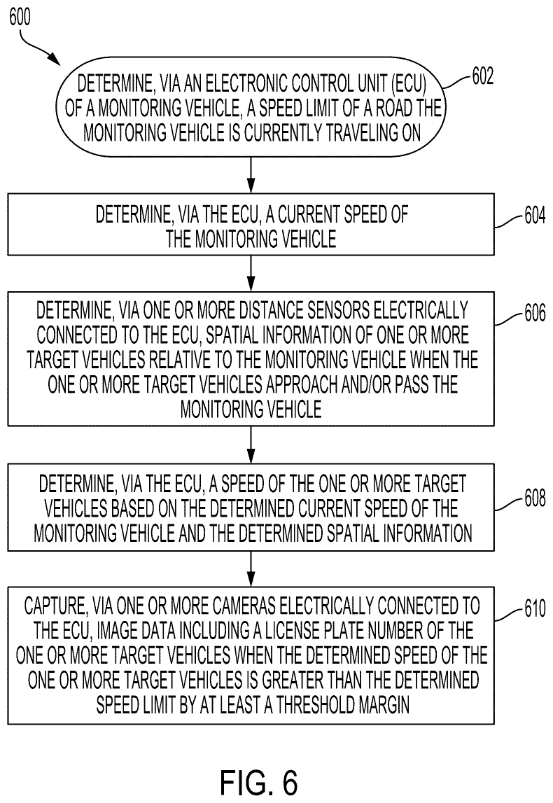

FIG. 6 is a flow diagram of an example process 600 for controlling the speed tracking and recording system 100. One or more computers or one or more data processing apparatuses, for example, the ECU 106 of the speed tracking and recording system 100 of FIG. 1, appropriately programmed, may implement the process 600. For ease of description, the process 600 is described below with reference to FIGS. 1-5. The process 600 of the present disclosure, however, is not limited to use of the exemplary speed tracking and recording systems of FIGS. 1-5.

The speed tracking and recording system 100 may determine, via the ECU 106 of the vehicle 102 (i.e., the monitoring vehicle), a speed limit of the road 408 the vehicle 102 is currently traveling on (602). In examples, the ECU 106 may determine the speed limit of the road 408 based on the navigational map information that is received from the navigation unit 136. The navigational map information may indicate the speed limit of the road 408 that the vehicle 102 is currently traveling on. In examples, the ECU 106 may determine the speed limit of the road 408 based on a current location of the vehicle 102 (e.g., that is received from the navigation unit 136). For example, the ECU 106 may utilize the current location of the vehicle 102 to look up the speed limit of the road 408 in a remote database (e.g., the remote database 142). In examples, the ECU 106 may determine the speed limit of the road 408 based on road image (or video) data received from the one or more cameras 116. The road image data may include the speed limit sign 404 positioned along the road 408 and the speed limit displayed on the speed limit sign 404.

The speed tracking and recording system 100 may further determine, via the ECU 106, a current speed of the vehicle 102 (604). In examples, the ECU 106 may determine the current speed of the vehicle 102 based on the speed data received from the speed sensor 112 and/or the vehicle information received from the navigation unit 136.

The speed tracking and recording system 100 may further determine, via the one or more distance sensors 118 electrically connected to the ECU 106, spatial information of the one or more target vehicles 402 relative to the vehicle 102 when the one or more target vehicles 402 approach and/or pass the vehicle 102 (e.g., in an opposite lane or from behind the vehicle 102 and in the same lane as the vehicle 102 or in one or more adjacent lanes) (606).

The speed tracking and recording system 100 may further determine, via the ECU 106, a speed of the one or more target vehicles 402 based on the determined current speed of the vehicle 102 and the determined spatial information (608). The determined spatial information may include an indication of when the one or more target vehicles 402 entered at least two respective sensor detection zones of the one or more distance sensors 118, and/or a period of time taken by the one or more target vehicles 402 to drive through one or more respective sensor detection zones of the one or more distance sensors 118.

The speed tracking and recording system 100 may capture, via the one or more cameras 116 electrically connected to the ECU 106, image data including a license plate number of the one or more target vehicles 402 when the determined speed of the one or more target vehicles 402 is greater than the determined speed limit by at least a threshold margin (or greater than the determined speed limit minus the threshold margin when the threshold margin is negative) (610). The threshold margin may be a numerical value and/or a percentage of the determined speed limit. In examples, the threshold margin may be the numerical value and/or the percentage of the determined speed limit, and may be based on a margin of error of the determined speed of the one or more target vehicles 402. For example, the threshold margin may increase as the margin of error increases. In addition or alternatively, in examples, the threshold margin may be the numerical value and/or the percentage of the determined speed limit, and may be based on one or more conditions of the road 408 and/or one or more weather conditions. For example, the threshold margin may be lower or may be negative when the road 408 is wet, icy, and/or sandy, and/or when it is raining or snowing, and/or when visibility is low due to rain, snow, fog, or dust.

In examples, the speed tracking and recording system 100 may transmit, via the network access device 114 electrically connected to the ECU 106, the image data and the determined speed of the one or more target vehicles 402 to the user device 144 and/or the remote database 142 when the determined speed of the one or more target vehicles 402 is greater than the determined speed limit by at least the threshold margin.

In examples, the speed tracking and recording system 100 may further determine, via the navigation unit 136 electrically connected to the ECU 106, location information of the vehicle 102. The location information may include a current location of the vehicle 102.

In examples, the speed tracking and recording system 100 may further transmit, via the network access device 114, the location information to the user device 144 and/or the remote database 142 when the determined speed of the one or more target vehicles 402 is greater than the determined speed limit by at least the threshold margin. The location information may be associated with the image data and the determined speed of the one or more target vehicles 402. The location information may indicate the current location of the vehicle 102 when the image data was captured. This may be used to determine the location of the one or more target vehicles 402 at the time the one or more target vehicles 402 were determined to be traveling at a speed that is greater than the determined speed limit by at least the threshold margin.

In examples, the speed tracking and recording system 100 may store, via the memory 108 electrically connected to the ECU 106, the image data, the determined speed limit, the determined speed of the one or more target vehicles 402, the location information, and/or the threshold margin.

Exemplary embodiments of the invention have been disclosed in an illustrative style. Accordingly, the terminology employed throughout should be read in a non-limiting manner. Although minor modifications to the teachings herein will occur to those well versed in the art, it shall be understood that what is intended to be circumscribed within the scope of the patent warranted hereon are all such embodiments that reasonably fall within the scope of the advancement to the art hereby contributed, and that that scope shall not be restricted, except in light of the appended claims and their equivalents.

What is claimed is:

1. A speed tracking and recording system for a monitoring vehicle, comprising:
one or more cameras configured to capture image data of a license plate number of one or more target vehicles;
one or more distance sensors configured to determine spatial information of the one or more target vehicles relative to the monitoring vehicle; and
an electronic control unit (ECU) electrically connected to the one or more cameras and the one or more distance sensors and configured to:
determine a speed limit of a road the monitoring vehicle is currently traveling on,
determine a current speed of the monitoring vehicle,
receive the spatial information from the one or more distance sensors when the one or more target vehicles approach and/or pass the monitoring vehicle on the road,
determine a speed of the one or more target vehicles based on the determined current speed of the monitoring vehicle and the received spatial information, and
control the one or more cameras to capture the image data when the determined speed of the one or more target vehicles is greater than the determined speed limit by at least a threshold margin.

2. The speed tracking and recording system of claim 1, wherein the ECU is further configured to transmit the image data and the determined speed of the one or more target vehicles to a user device and/or a remote database when the determined speed of the one or more target vehicles is greater than the determined speed limit by at least the threshold margin

3. The speed tracking and recording system of claim 2, further comprising a navigation unit electrically connected to the ECU and configured to determine location information of the monitoring vehicle;
wherein the ECU is further configured to transmit the location information to the user device and/or the remote database when the determined speed of the one or more target vehicles is greater than the determined speed limit by at least the threshold margin.

4. The speed tracking and recording system of claim 1, wherein the threshold margin is a numerical value or a percentage of the determined speed limit.

5. The speed tracking and recording system of claim 1, wherein the threshold margin is based on a margin of error of the determined speed of the one or more target vehicles.

6. The speed tracking and recording system of claim 1, wherein the threshold margin is based on one or more conditions of the road and/or one or more weather conditions.

7. The speed tracking and recording system of claim 1, further comprising a memory electrically connected to the ECU and configured to store the image data, the determined speed of the one or more target vehicles, and/or the threshold margin.

8. The speed tracking and recording system of claim 1, wherein:
the one or more distance sensors each have a sensor detection zone; and
the received spatial information includes:
an indication of when the one or more target vehicles entered at least two respective sensor detection zones of the one or more distance sensors, and/or
a period of time taken by the one or more target vehicles to drive through one or more respective sensor detection zones of the one or more distance sensors.

9. The speed tracking and recording system of claim 1, wherein the one or more distance sensors are coupled to an exterior surface of the monitoring vehicle.

10. The speed tracking and recording system of claim 1, wherein the one or more distance sensors include one or more of a radar sensor, a lidar sensor, an ultrasonic sensor, and/or a camera.

11. A method for tracking and recording a speed of one or more target vehicles by a monitoring vehicle, the method comprising:
determining, via an electronic control unit (ECU) of the monitoring vehicle, a speed limit of a road the monitoring vehicle is currently traveling on;
determining, via the ECU, a current speed of the monitoring vehicle;
determining, via one or more distance sensors electrically connected to the ECU, spatial information of the one or more target vehicles relative to the monitoring vehicle when the one or more target vehicles approach and/or pass the monitoring vehicle;
determining, via the ECU, a speed of the one or more target vehicles based on the determined current speed of the monitoring vehicle and the determined spatial information; and
capturing, via one or more cameras electrically connected to the ECU, image data including a license plate number of the one or more target vehicles when the determined speed of the one or more target vehicles is greater than the determined speed limit by at least a threshold margin.

12. The method of claim 11, further comprising transmitting, via a network access device electrically connected to the ECU, the image data and the determined speed of the one or more target vehicles to a user device and/or a remote database when the determined speed of the one or more target vehicles is greater than the determined speed limit by at least the threshold margin.

13. The method of claim 12, further comprising:
determining, via a navigation unit electrically connected to the ECU, location information of the monitoring vehicle; and
transmitting, via the network access device, the location information to the user device and/or the remote database when the determined speed of the one or more target vehicles is greater than the determined speed limit by at least the threshold margin.

14. The method of claim 11, wherein the threshold margin is a numerical value or a percentage of the determined speed limit.

15. The method of claim 11, wherein the threshold margin is based on a margin of error of the determined speed of the one or more target vehicles.

16. The method of claim 11, wherein the threshold margin is based on one or more conditions of the road and/or one or more weather conditions.

17. The method of claim 11, further comprising storing, via a memory electrically connected to the ECU, the image data, the determined speed of the one or more target vehicles, and/or the threshold margin.

18. The method of claim 11, wherein:
the one or more distance sensors each have a sensor detection zone; and
the determined spatial information includes:
an indication of when the one or more target vehicles entered at least two respective sensor detection zones of the one or more distance sensors, and/or
a period of time taken by the one or more target vehicles to drive through one or more respective sensor detection zones of the one or more distance sensors.

19. The method of claim 11, wherein the one or more distance sensors are coupled to an exterior surface of the monitoring vehicle.

20. The method of claim 11, wherein the one or more distance sensors include one or more of a radar sensor, a lidar sensor, an ultrasonic sensor, and/or a camera.
